(19) United States
(12) Patent Application Publication
(10) Pub. No.: US 2026/0118267 A1
(43) Pub. Date: Apr. 30, 2026

(54) Devices, Systems, and Methods for Calibration Systems

(71) Applicant: IDEXX LABORATORIES, INC., Westbrook, ME (US)

(72) Inventors: Ashley Allen Carr, North Yarmouth, ME (US); David Sinnett, Falmouth, ME (US); Sarah Carpenter, Steep Falls, ME (US); Jesse Faller, Portland, ME (US); Berkeley Elias, Saco, ME (US); Dominic Pelletier, Raymond, ME (US)

(21) Appl. No.: 19/368,930

(22) Filed: Oct. 24, 2025

Related U.S. Application Data
(60) Provisional application No. 63/712,201, filed on Oct. 25, 2024.

(51) Int. Cl. G01N 21/55; G01N 21/84

(52) U.S. Cl. CPC G01N 21/55; G01N 21/8483; G01N 2201/06106; G01N 2201/0623; G01N 2201/12746

(57) ABSTRACT

A method for calibrating an optics module on a chemistry analyzer is disclosed. The method includes measuring a first reflectance value for a first chemistry slide, wherein the first chemistry slide comprises a first chemical substance, and wherein the first chemical substance is associated with a first global reflectance reference value. The method includes generating a first comparison of the first reflectance value and the first global reflectance reference value. The method includes measuring a second reflectance value for a second chemistry slide, wherein the second chemistry slide comprises a second chemical substance, and wherein the second chemical substance is associated with a second global reflectance reference value. The method includes generating a second comparison of the second reflectance value and the second global reflectance reference value. The method includes based on at least one of the first comparison or the second comparison, calibrating one or more components of the optics module.

### RELATED APPLICATION

This application claims priority to U.S. Provisional Application No. 63/712,201 filed Oct. 25, 2024 which is incorporated herein by reference in its entirety.

### FIELD OF THE DISCLOSURE

The present disclosure involves devices, systems, and methods for calibrating an optics module on a chemistry analyzer. Namely, devices, systems, and methods of the disclosure utilize reflectance values for different chemistry slides to calibrate an optics module and/or one or more additional components of a chemistry analyzer.

### BACKGROUND

Chemistry analyzers can be used to calculate the concentration of certain substances, including one or more of serum, plasma, urine, or other biological fluids and/or substances.

### SUMMARY

When determining a health status of a patient (e.g., a human patient or an animal patient), technicians typically use chemistry analyzers to evaluate different biological fluids and/or substances. For example, a chemistry analyzer may include one or more optics modules (e.g., herein referred to as an “optics module” or “optics modules”) and/or one or more additional sensors and/or modules that are configured to receive and analyze one or more test samples, including those containing one or more biological fluids (e.g., blood). Before doing so, however, the chemistry analyzer may require calibration to address one or more components or operational state parameters of the chemistry analyzer (e.g. one or more optics modules) that have become incorrectly calibrated (e.g., due to use, environmental factors, etc.).

In some examples, these calibration issues may be due to one or more reasons, including changes, wear and tear, degradation, misalignment, cleanliness, and/or temperature fluctuations of the chemistry analyzer and/or one or more components thereof (including the optics module). When this incorrect calibration occurs, the optics module may require recalibration to correctly focus on and/or analyze the different chemistry slides to determine one or more parameters of each chemical substance thereon. Thus, there may be a need to frequently analyze the calibration of one or more components of the chemistry analyzer and recalibrate these components to ensure the accuracy and/or precision of one or more operational parameters and accuracy of the chemistry analyzer.

In one example, one or more components of an optics module may become incorrectly calibrated. In these examples, these optics module components may be recalibrated to more accurately measure the reflectance values prior to processing a test sample on the slide (also known as a “dry reading”) or the readings of the chemical reaction that takes place after applying the sample fluid to the slide, which, when compared to a target reflectance value for the particular chemistry slide, is indicative of the degree of optics module calibration accuracy. In some examples, the chemistry slide may include one or more diagnostic materials and/or substances, including a reagent strip.

In some scenarios, the optics module may further benefit from calibration using a dedicated, single-use consumable, reference target, such as a white reference slide. To improve this calibration, the reference target may include an inert chemistry chip with stable and high reflectivity characteristics across a particular wavelength range (e.g., between 350 nanometers and 780 nanometers). Further, in some examples, the reflectance values of the reference target (including a white optical slide) may be calibrated to correlate with one or more global reference values.

For example, the optics module may utilize the reference target (including a white optical slide) to recalibrate the LED drive currents in the chemistry analyzer in which the reference target resides and/or one or more chemistry analyzers in communication with the chemistry analyzer. This calibration may be required for maintaining accuracy and reducing instrument-to-instrument variability (e.g., variability between different chemistry analyzers). However, the reference target (including a white optical slide) may not be usable when the optics module is outside of one or more predetermined tolerances and/or calibration. Further, these reference targets may only be used once (e.g., the reference target may become contaminated, which can change the calibrated reflectance values of the chemistry analyzer, the optics module, or both, among other possibilities) and may take significant time to use for recalibration.

In a further aspect, when the chemistry analyzer operates outside of the predetermined tolerance and/or calibration, the chemistry analyzer may display a message indicating that calibration is required, and operation of the chemistry analyzer may be interrupted until a calibration test on a new reference target is performed. In some scenarios, technicians (e.g., clinicians, customers) may not be able to proactively acquire a reference target. As a result, expensive overnight shipping of the reference target may be undergone to enable technicians to resume use of the chemistry analyzer. In some scenarios, the process of shipping a new reference target to calibrate the chemistry analyzer may take up to 72 hours and these calibration delays may result in an inability to diagnose, treat, and otherwise care for patients.

To reduce the delay, in some examples, the techniques described herein utilize a series of chemistry slides, each containing one or more chemical substances with known global reflectance reference values, to monitor the calibration state of the chemistry analyzer. In some examples, these slides (and others, including one or more reference targets) may be optically and mechanically stable and may have high, consistent reflectance across one or more particular wavelength ranges (e.g., between 350 nanometers and 780 nanometers).

In a further aspect, in some embodiments, these chemistry slides (e.g., dry read data) may be used along with a reference target to measure one or more values (e.g., reflectance values), which may in turn be used to set and/or update global reference values. In examples, these measured values may be analyzed, communicated, and/or used to update chemistry analyzers throughout a network of chemistry analyzers.

In examples, one or more chemistry analyzers may analyze chemistry slides including one or more chemical substances that measure an analyte (examples of analytes include alkaline phosphatase, blood urea nitrogen, creatinine, glucose, etc.) to inform and update global reference values and/or other parameters utilized by a chemistry analyzer during calibration. In examples, the dry read data (e.g., reflectance values measured prior to exposing the slide to patient sample or other fluids) from the chemistry slides may be compared with target dry read data (e.g., predetermined global reflectance reference values that are associated with the one or more substances on the chemistry slide) collected during pre-shipment of the chemistry slides. In some embodiments, the target dry read may correspond to a mean dry read value for a particular slide lot. The mean dry read value may be determined by averaging dry read values for chemistry slides across multiple instruments (e.g., chemistry analyzers) while filtering outlier values.

Based on the comparison of the dry read data with the target dry read data, the chemistry analyzer may determine that the global reflectance reference value anticipated for the chemical substances on these slides is outside of a target threshold of the values that are measured during calibration and one or more components of the chemical analyzer can be adjusted based on a comparison of the measured reflectance values and the reference reflectance values of the one or more slides.

In examples, to do so, the chemistry analyzer may measure reflectance of the chemical substance on the slide, where the measured reflectance (“R”) is determined by dividing the measured intensity of light reflected off the chemical substance by the intensity of light impinged on the substance. Measuring and analyzing such reflectance values as described in this application may be the same as is used in the optics module described in U.S. Patent Application Publication No. 2010/0254854, U.S. Pat. Nos. 7,616,317, and/or 9,797,916, the disclosures of which are incorporated herein by reference.

In some examples, the chemistry analyzer may then convert the measured reflectance (“R”) to a normalized reflectance value (“NR”) to determine the magnitude of miscalibration, which may be represented using one or more scalar values (“S”). As used herein, the global reflectance reference values associated with the one or more particular chemical substances are based on calibrated samples of the one or more chemical substances, which, as used herein means a sample that has global reflectance reference values assigned at one or more wavelength(s) of interest. In examples, these global reflectance reference values are often traceable to an accredited standard and calibration may be based on setting one or more scalar values to reconcile the difference between the measured reflectance and the global reflectance reference value. In some examples, this calculation may follow the form:

NR(Calibrated)=R*S=Global Reflectance Reference Value

In the example above, a linear raw reflectance response (R) of zero to an arbitrary number is assumed. However, this assumption is not required and other examples are possible. One of skill in the art could adjust the above approach to accommodate for such situations.

In examples, by using this scalar value adjustment approach, the methods and systems described herein reduce instrument to instrument variability that is inherent to the measurement of one or more values of the chemistry analyzer (e.g., measured reflectance values). Further, in examples, these nominal reflectance values established during chemistry slide calibration can be used to set and/or update the global reflectance reference values during calibration of the optics module. Further, in some examples, by using the measured aggregate of multiple chemistry slides to inform the direction and magnitude of the calibration adjustment, improved calibration for any given chemistry analyzer, as well as any network of chemistry analyzers, will be improved.

Further, as described in the examples herein, the collection and analysis of these values may be performed by the chemistry analyzer both during and outside of the normal operation of the chemistry analyzer to ensure that the reflectance values of the chemistry slides can be used to adjust a calibration state of the chemistry analyzer and other chemistry analyzers—all without interrupting the operation of the chemistry analyzer. As a result, the delays associated with obtaining a new reference target are reduced (e.g., eliminated). Furthermore, there is no need to wait for the chemistry analyzer to perform a calibration sequence, as the chemistry analyzer may be calibrated before and/or in parallel during each use.

In example embodiments, a method for calibrating an optics module on a chemistry analyzer is disclosed. In examples, the method includes measuring a first reflectance value for a first chemistry slide, wherein the first chemistry slide comprises a first chemical substance, and wherein the first chemical substance is associated with a first global reflectance reference value. In examples, the method includes generating a first comparison of the first reflectance value and the first global reflectance reference value. In examples, the method includes measuring a second reflectance value for a second chemistry slide, wherein the second chemistry slide comprises a second chemical substance, and wherein the second chemical substance is associated with a second global reflectance reference value. In examples, the method includes generating a second comparison of the second reflectance value and the second global reflectance reference value. In examples, the method includes based on at least one of the first comparison or the second comparison, calibrating one or more components of the optics module.

In another example, a chemistry analyzer is described. In some examples, the chemistry analyzer includes an optics module, one or more processors, and a tangible, non-transitory computer-readable medium comprising instructions that, when executed by the one or more processors, cause performance of a set of operations. In some examples, the set of operations includes: (i) measuring a first reflectance value for a first chemistry slide, wherein the first chemistry slide comprises a first chemical substance, and wherein the first chemical substance is associated with a first global reflectance reference value; (ii) generating a first comparison of the first reflectance value and the first global reflectance reference value; (iii) measuring a second reflectance value for a second chemistry slide, wherein the second chemistry slide comprises a second chemical substance, and wherein the second chemical substance is associated with a second global reflectance reference value; (iv) generating a second comparison of the second reflectance value and the second global reflectance reference value; and (v) based on at least one of the first comparison or the second comparison, calibrating one or more components of the optics module.

In another example, a tangible, non-transitory computer-readable medium comprising instructions that, when executed by the one or more processors, cause performance of a set of operations is described. In some examples, the set of operations includes: (i) measuring a first reflectance value for a first chemistry slide, wherein the first chemistry slide comprises a first chemical substance, and wherein the first chemical substance is associated with a first global reflectance reference value; (ii) generating a first comparison of the first reflectance value and the first global reflectance reference value; (iii) measuring a second reflectance value for a second chemistry slide, wherein the second chemistry slide comprises a second chemical substance, and wherein the second chemical substance is associated with a second global reflectance reference value; (iv) generating a second comparison of the second reflectance value and the second global reflectance reference value; and (v) based on at least one of the first comparison or the second comparison, calibrating one or more components of the optics module.

In another example, a method for calibrating an optics module on a chemistry analyzer is disclosed. In examples, the method includes measuring a reflectance value for a chemistry slide, wherein the chemistry slide comprises a chemical substance, and wherein the chemical substance is associated with a global reflectance reference value. In examples, the method includes generating a comparison of the reflectance value and the global reflectance reference value. In examples, the method includes based on the comparison, calibrating one or more components of the optics module.

In another example, a chemistry analyzer is described. In some examples, the chemistry analyzer includes an optics module, one or more processors, and a tangible, non-transitory computer-readable medium comprising instructions that, when executed by the one or more processors, cause performance of a set of operations. In some examples, the set of operations includes: (i) measuring a reflectance value for a chemistry slide, wherein the chemistry slide comprises a chemical substance, and wherein the chemical substance is associated with a global reflectance reference value; (ii) generating a comparison of the reflectance value and the global reflectance reference value; and (iii) based on at least one of the comparison, calibrating one or more components of the optics module.

In another example, a tangible, non-transitory computer-readable medium comprising instructions that, when executed by the one or more processors, cause performance of a set of operations is described. In some examples, the set of operations includes: (i) measuring a reflectance value for a chemistry slide, wherein the chemistry slide comprises a chemical substance, and wherein the chemical substance is associated with a global reflectance reference value; (ii) generating a comparison of the reflectance value and the global reflectance reference value; and (iii) based on the comparison, calibrating one or more components of an optics module of a chemistry analyzer.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a block diagram of a chemistry analyzer that is configured to calibrate an optics module using dry slides, according to an example embodiment.

FIG. 2 illustrates a diagram of a slide tray, according to an example embodiment.

FIG. 3 illustrates a simplified block diagram of an example computing device, according to an example embodiment.

FIG. 4 illustrates a diagram of an example computing system, according to an example embodiment.

FIG. 5 illustrates a diagram of an example computing system, according to an example embodiment.

FIG. 6 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers may refer to the same or similar elements or components throughout.

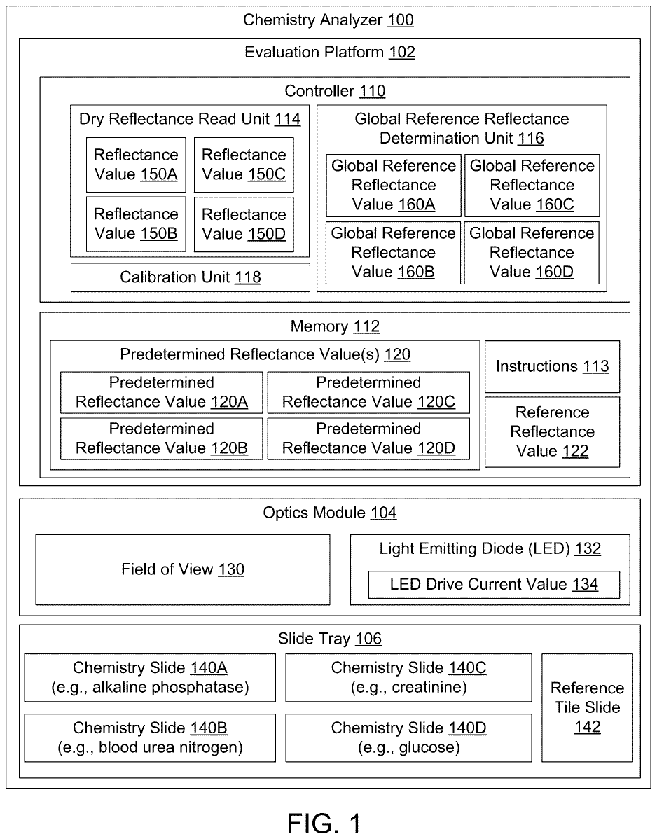

Referring now to the figures, FIG. 1 is a block diagram of a chemistry analyzer 100 that is configured to calibrate an optics module using one or more dry chemistry slides, according to an example embodiment. In particular, the chemistry analyzer 100 may be configured to calibrate one or more components of the optics module based on reflectance values of dry chemistry slides (and, potentially, reference targets) to analyze test samples.

In examples, the chemistry analyzer 100 includes an evaluation platform 102, an optics module 104, and a slide tray 106. In examples, the evaluation platform 102 includes a controller 110 and a memory 112. In examples, the memory 112 may be a non-transitory computer-readable medium that includes instructions 113 executable by the controller 110 to perform the operations described herein.

In examples, the controller 110 includes a dry reflectance read unit 114, a global reference reflectance determination unit 116, and a calibration unit 118. In some examples, one or more components of the controller 110 can be implemented using dedicated hardware. To illustrate, in some examples, one or more components of the controller 110 can be implemented using an application-specific integrated circuit (ASIC) or a field-programmable gate array (FPGA) device. In other examples, one or more components of the controller 110 can be implemented using software. To illustrate, in some examples, some components of the controller 110 can be implemented by executing the instructions 113 stored in the memory 112.

The optics module 104 includes a field of view 130 and a light emitting diode (LED) 132. During operation, different chemistry slides 140 can be placed in the field of view 130. In examples, when a particular chemistry slide 140 is placed within the field of view 130 of the optics module 104, a test sample of one or more samples (e.g., a biological sample like blood, urine, feces extract, fine needle aspirate, milk, etc.) may also be analyzed in connection with the particular chemistry slide 140. In examples, light generated by the LED 132 may be applied to (e.g., focused on) the field of view 130 to analyze the particular chemistry slide 140. Based on the interaction (e.g., the reflectance), levels of a particular substance in the particular chemistry slide 140 can be determined, which in turn may be utilized to calibrate one or more components of the chemistry analyzer 100 and/or one or more chemistry analyzers with which the chemistry analyzer 100 may communicate.

To illustrate, in examples, the slide tray 106 may include a chemistry slide 140A, a chemistry slide 140B, a chemistry slide 140C, and a chemistry slide 140D, and a reference target 142. In examples, each chemistry slide 140 may comprise a different chemical substance that measures an analyte (examples of analytes include alkaline phosphatase, blood urea nitrogen, creatinine, glucose, etc.). As a non-limiting example, the chemistry slide 140A may correspond to an alkaline phosphatase chemistry slide (e.g., to determine levels of alkaline phosphatase in a biological sample), the chemistry slide 140B may correspond to a blood urea nitrogen chemistry slide (e.g., to determine levels of blood urea nitrogen in a biological sample), the chemistry slide 140C may correspond to a creatinine chemistry slide (e.g., to determine levels of creatinine in a biological sample), and the chemistry slide 140A may correspond to a glucose chemistry slide (e.g., to determine levels of glucose in a biological sample). It should be understood that the above examples of the chemistry slides 140 are merely for illustrative purposes and should not be construed as limiting. Although four chemistry slides 140A-140D are depicted, in some embodiments, the slide tray 106 can include additional (or fewer) chemistry slides 140. As a non-limiting example, in some embodiments, the slide tray 106 may include eighteen or more different chemistry slides 140 to enable level testing of eighteen different substances. In examples, the chemistry slides 140 may also comprise reagent strips.

In examples, a reflectance metric of the chemical substance that measures an analyte (examples of analytes include alkaline phosphatase, blood urea nitrogen, creatinine, glucose, etc.) associated with the chemistry slides 140 may exceed a wavelength of interest of the chemistry analyzer 100. In examples, the wavelength of interest may be between 350 nanometers and 780 nanometers. However, in other examples, different chemical substances that are outside the wavelength of interest may be associated with the chemistry slides 140.

In examples, the LED 132 may be applied to a particular chemistry slide 140 to facilitate measurement of reflectance properties of one or more chemical substances on the particular chemistry slide 140. In examples, when testing for reflectance values of one or more particular chemical substances, if one or more components of the chemistry analyzer 100 are not correctly calibrated, then the measured reflectance properties of the one or more chemical substances on the particular chemistry slide 140 may not be accurately or precisely indicative of the levels of the particular substance on the particular chemistry slide 140. Thus, in examples, the disclosed techniques enable calibration of these one or more components for each use of the chemistry analyzer 100 (e.g., using dry reads of the chemistry slides 140) to ensure that the reflectance properties of any substance analyzed by the chemical analyzer 100 (including biological test samples) are accurate. In examples, this calibration ensures that the resultant output is within a threshold value of the predetermined reflectance values of the chemical substance and substance levels in the one or more chemistry slides 140, and, if not, then one or more calibration protocols may be implemented.

In examples, predetermined reflectance values 120 for the chemistry slides 140 may be stored in the memory 112. In examples, a predetermined reflectance value 120A for the chemistry slide 140A used to determine levels of alkaline phosphatase is stored in the memory 112, a predetermined reflectance value 120B for the chemistry slide 140B used to determine levels of blood urea nitrogen is stored in the memory 112, a predetermined reflectance value 120C for the chemistry slide 140C used to determine levels of creatinine is stored in the memory 112, and a predetermined reflectance value 120D for the chemistry slide 140D used to determine levels of glucose is stored in the memory 112. In examples, the predetermined reflectance values 120 may be collected during pre-shipment of the chemistry slides 140. In examples, these predetermined reflectance values 120 may also be the basis for one or more global reflectance reference values associated with one or more chemical substances on the chemistry slides 140.

In examples, prior to using the chemistry slide 140A to determine a level of alkaline phosphatase in a biological test sample (e.g., during “downtime” of the chemistry analyzer 100), a dry version of the chemistry slide 140A may be used to calibrate one or more components (e.g., one or more components of the optics module) for alkaline phosphatase testing. To illustrate, a dry version of the chemistry slide 140A may be positioned within the field of view 130 of the optics module 104. In examples, the dry reflectance read unit 114 may be configured to determine a reflectance value 150A for the chemistry slide 140A while the chemistry slide 140A is in the field of view 130 of the optics module 104. For example, the reflectance read unit 114 may be configured to perform a dry reflectance read on the chemistry slide 140A while the chemistry slide 140A is in the field of view 130. In examples, the dry reflectance read unit 114 may determine the reflectance value 150A for the dry version of the chemistry slide 140A.

In examples, the global reference reflectance determination unit 116 may be configured to compare the reflectance value 150A to the predetermined reflectance value 120A for the chemistry slide 140A, which in turn may be compared to a global reference reflectance value 160A. Thus, in examples, the global reference reflectance value 160A may indicate the difference between the predetermined reflectance value 120A (e.g., the “target” reflectance value) for the dry chemistry slide 140A and the actual reflectance value 150A (e.g., the “measured” reflectance value) for the dry chemistry slide 140A.

In examples, the difference indicated by the global reference reflectance value 160A can be used to determine (and ultimately set) one or scalar values to reconcile the difference between the measured reflectance and the global reflectance reference value. For example, the one or more components of the optics module 104 and/or one or more components of the chemistry analyzer 100 can be calibrated (e.g., adjusted) until the difference between a measured reflectance value of the dry chemistry slide and the reference reflectance value 122 (which, in examples, may be stored in the memory 112) associated with the one or more chemical substances on the dry chemistry slide substantially matches the difference indicated by the global reference reflectance value 160A. The reference reflectance value 122 may correspond to a reflectance value of the chemical substances collected during pre-shipment of the chemistry slides and one or more of the measured and/or reconciled values may be transmitted to the evaluation platform 102 and may be used to update one or more chemical analyzer reference values stored in the evaluation platform 102 and/or memory 112. By calibrating these one or more components in such a manner, accurate level readings of alkaline phosphatase in the biological test sample may be achieved, both locally for the chemistry analyzer 100, as well as chemistry analyzers throughout a network of chemistry analyzers in communication with the evaluation platform.

Similarly, in other examples, the additional chemistry slides illustrated in FIG. 1 may be used to calibrate the one or more components in the chemistry analyzer 100. For example, chemistry slide 140B may contain a chemical substance to measure blood urea nitrogen, which may be measured and used to calibrate one or more components of the chemistry analyzer 100. To illustrate, a dry version of the chemistry slide 140B may be positioned within the field of view 130 of the optics module 104. In examples, the dry reflectance read unit 114 may be configured to determine a reflectance value 150B for the chemistry slide 140B while the chemistry slide 140B and the dry reflectance read unit 114 may determine the reflectance value 150B for the dry version of the chemistry slide 140B.

In examples, the global reference reflectance determination unit 116 may be configured to compare the reflectance value 150B to the predetermined reflectance value 120B for the chemistry slide 140B, which in turn may be compared to a global reference reflectance value 160B. Thus, in examples, the global reference reflectance value 160B may indicate the difference between the predetermined reflectance value 120B (e.g., the “target” reflectance value) for the dry chemistry slide 140B and the actual reflectance value 150B (e.g., the “measured” reflectance value) for the dry chemistry slide 140B.

In examples, the difference indicated by the global reference reflectance value 160B can be used to determine (and ultimately set) one or scalar values to reconcile the difference between the measured reflectance and the global reflectance reference value. For example, the one or more components of the optics module and/or one or more components of the chemistry analyzer 100 can be calibrated (e.g., adjusted) until the difference between a measured reflectance value of the dry chemistry slide and the reference reflectance value 122 associated with the one or more chemical substances on the dry chemistry slide substantially matches the difference indicated by the global reference reflectance value 160B. The reference reflectance value 122 may correspond to a reflectance value of the chemical substances collected during pre-shipment of the chemistry slides and one or more of the measured and/or reconciled values may be transmitted to the evaluation platform 102 and may be used to update one or more chemical analyzer reference values stored in the evaluation platform 102 and/or memory 112. By calibrating these one or more components in such a manner, accurate level readings of blood urea nitrogen in the biological test sample may be achieved, both locally for the chemistry analyzer 100, as well as chemistry analyzers throughout a network of chemistry analyzers in communication with the evaluation platform.

Similarly, in other examples, the additional chemistry slides illustrated in FIG. 1 may be used to calibrate the one or more components in the chemistry analyzer 100. For example, chemistry slide 140C may contain a chemical substance to measure creatinine, which may be measured and used to calibrate one or more components of the chemistry analyzer 100. To illustrate, a dry version of the chemistry slide 140C may be positioned within the field of view 130 of the optics module 104. In examples, the dry reflectance read unit 114 may be configured to determine a reflectance value 150C for the chemistry slide 140C while the chemistry slide 140C and the dry reflectance read unit 114 may determine the reflectance value 150C for the dry version of the chemistry slide 140C.

In examples, the global reference reflectance determination unit 116 may be configured to compare the reflectance value 150C to the predetermined reflectance value 120C for the chemistry slide 140C, which in turn may be compared to a global reference reflectance value 160C. Thus, in examples, the global reference reflectance value 160C may indicate the difference between the predetermined reflectance value 120C (e.g., the “target” reflectance value) for the dry chemistry slide 140C and the actual reflectance value 150C (e.g., the “measured” reflectance value) for the dry chemistry slide 140C.

In examples, the difference indicated by the global reference reflectance value 160C can be used to determine (and ultimately set) one or scalar values to reconcile the difference between the measured reflectance and the global reflectance reference value. For example, the one or more components of the optics module and/or one or more components of the chemistry analyzer 100 can be calibrated (e.g., adjusted) until the difference between a measured reflectance value of the dry chemistry slide and the reference reflectance value 122 associated with the one or more chemical substances on the dry chemistry slide substantially matches the difference indicated by the global reference reflectance value 160C. The reference reflectance value 122 may correspond to a reflectance value of the chemical substances collected during pre-shipment of the chemistry slides and one or more of the measured and/or reconciled values may be transmitted to the evaluation platform 102 and may be used to update one or more chemical analyzer reference values stored in the evaluation platform 102 and/or memory 112. By calibrating these one or more components in such a manner, accurate level readings of creatinine in the biological test sample may be achieved, both locally for the chemistry analyzer 100, as well as chemistry analyzers throughout a network of chemistry analyzers in communication with the evaluation platform.

Similarly, in other examples, the additional chemistry slides illustrated in FIG. 1 may be used to calibrate the one or more components in the chemistry analyzer 100. For example, chemistry slide 140D may contain a chemical substance to measure glucose, which may be measured and used to calibrate one or more components of the chemistry analyzer 100. To illustrate, a dry version of the chemistry slide 140D may be positioned within the field of view 130 of the optics module 104. In examples, the dry reflectance read unit 114 may be configured to determine a reflectance value 150D for the chemistry slide 140D while the chemistry slide 140D and the dry reflectance read unit 114 may determine the reflectance value 150D for the dry version of the chemistry slide 140D.

In examples, the global reference reflectance determination unit 116 may be configured to compare the reflectance value 150D to the predetermined reflectance value 120D for the chemistry slide 140D, which in turn may be compared to a global reference reflectance value 160D. Thus, in examples, the global reference reflectance value 160D may indicate the difference between the predetermined reflectance value 120D (e.g., the “target” reflectance value) for the dry chemistry slide 140D and the actual reflectance value 150D (e.g., the “measured” reflectance value) for the dry chemistry slide 140D.

In examples, the difference indicated by the global reference reflectance value 160D can be used to determine (and ultimately set) one or scalar values to reconcile the difference between the measured reflectance and the global reflectance reference value. For example, the one or more components of the optics module and/or one or more components of the chemistry analyzer 100 can be calibrated (e.g., adjusted) until the difference between a measured reflectance value of the dry chemistry slide and the reference reflectance value 122 associated with the one or more chemical substances on the dry chemistry slide substantially matches the difference indicated by the global reference reflectance value 160D. The reference reflectance value 122 may correspond to a reflectance value of the chemical substances collected during pre-shipment of the chemistry slides and one or more of the measured and/or reconciled values may be transmitted to the evaluation platform 102 and may be used to update one or more chemical analyzer reference values stored in the evaluation platform 102 and/or memory 112. By calibrating these one or more components in such a manner, accurate level readings of glucose in the biological test sample may be achieved, both locally for the chemistry analyzer 100, as well as chemistry analyzers throughout a network of chemistry analyzers in communication with the evaluation platform.

Further, in examples, after the dry read values for the one or more chemistry slides 140A-140D are determined, the global reference reflectance determination unit 116 may be configured to compare the measured reflectance values 150A-150D to the predetermined reflectance values 120A-120D for the chemistry slides 140A-140D and/or the global reference reflectance values 160A-160D, respectively. In scenarios where reflectance values 150 for more than one chemistry slide 140 are determined, the global reference reflectance values 160 may be an average and/or other statistical representation of the measured and reconciled values of reflectance. Furthermore, although the above techniques describe four different chemical substances for each respective chemistry slide, these chemical substances may all be the same across the four chemistry slides (e.g., chemical substances that measure glucose) or some combination of these chemical substances, among other potential chemical substances. Other examples are possible.

For example, in example embodiments, the chemistry analyzer 100 may use measurements from multiple slides (e.g., multiple reflectance measurements from one or more chemistry slides) before calibrating one or more components of the chemistry analyzer 100, as increasing the number of reflectance measurements over the one or more chemistry slides improves any calibration based thereon (e.g., replicate measurements provide improved analysis due to manufacturing variability in the dry slides themselves). Furthermore, in example embodiments, these multiple readings may take place on the same day or run instance (e.g., the chemistry analyzer 100 may collect and cache the data until the aggregate threshold has been reached and then make one or more calibrations to one or more components of the chemistry analyzer based thereon). Furthermore, in examples, the frequency, timing, and other characteristics of these measurements may be made pursuant to one or more sets of rules, including rules concerning an eligible lifetime for a dry slide reading to be utilized by the chemistry analyzer 100 (e.g., one or more rules to not use measurements of dry read chemistry slides past a particular date and/or lifespan of the chemistry slide, weight one or more dry read chemistry slide measurements differently, etc.). In examples, these rules may restrict dry read usability to shorter timespans than the actual product expiration date, which would be specific to each chemistry slide and only exist if dry reads are not stable over the product lifespan. Other examples are possible.

The techniques described with respect to FIG. 1 reduce or eliminate delays associated with calibrating a chemistry analyzer. In particular, the techniques described with respect to FIG. 1 provide a mechanism for using dry slides 140 to calibrate one or more components of the chemistry analyzer 100 during normal use of the dry slides 140 for sample testing. As a result, the need to purchase, ship, and/or utilize reference targets (e.g., white tile) for calibration is reduced or eliminated. Thus, extensive delays associated with calibrating the chemistry analyzer 100, sometimes up to 72 hours, can be eliminated as the chemistry analyzer 100 can recalibrate each time a dry slide 140 is used to test samples for different substance levels. Furthermore, in examples, such dry read chemistry collection and analysis may be performed during and/or as part of the analysis of a biological test sample, without the technician programming the chemistry analyzer 100 to do so. For example, as part of the biological test sample, slide tray 106 may include a biological test sample in one or more chemistry slides and also include dry read chemistry slides in different portions of the slide tray (e.g., chemistry slides 140A-140D), as well as reference target 142. In examples, the chemistry analyzers may use one or more of the dry read chemistry slides and/or the reference target to calibrate one or more components of the chemistry analyzer before, during, or after the testing sequence of the one or more biological test sample. In this regard, calibration of the chemistry analyzer 100 may be part of and/or parallel to the analysis of the one or more biological test samples. Other examples are possible.

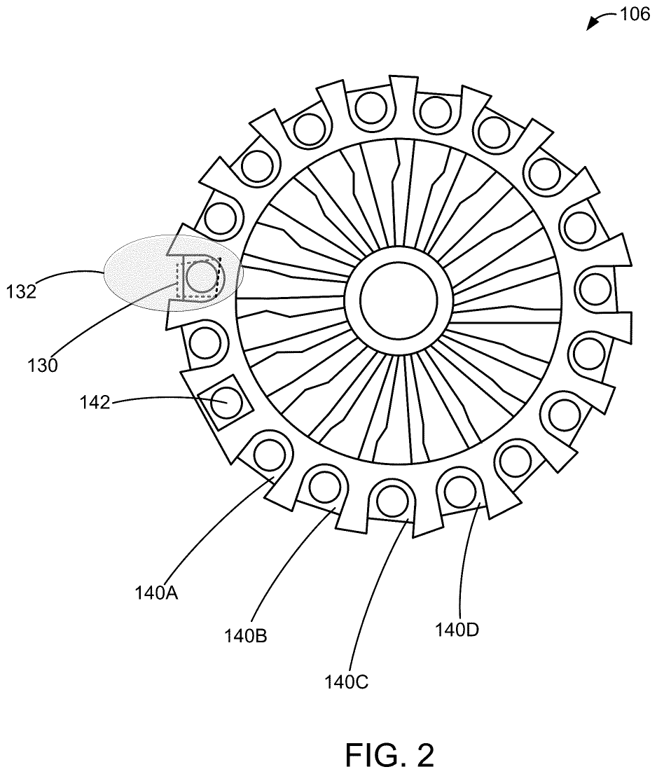

For example, in some example embodiments, a reference target may be used in combination with the above described features to calibrate one or more components of the chemistry analyzer. For example, FIG. 2 illustrates a diagram of the slide tray 106 that includes a reference target and a plurality of dry chemistry slides that are used to calibrate an optics module, according to an example embodiment. In examples, the slide tray 106 includes the reference target 142, the chemistry slide 140A, the chemistry slide 140B, the chemistry slide 140C, and the chemistry slide 140D. As depicted in FIG. 2, the slide tray 106 includes a plurality of other slots (e.g., positions) to insert chemistry slides that may be used to test for the levels and/or reflectance values of other substances.

During a first instance of downtime (e.g., when the chemistry analyzer 100 is not being used to test biological samples), the slide tray 106 may be rotated such that one or more of the chemistry slides 140A, 140B, 140C, and/or 140D are within the field of view 130 of the optics module 104 and the dry reflectance read unit 114 may determine the reflectance values 150A, 150B, 150C, and/or 150D corresponding to the chemistry slides 140A, 140B, 140C, and/or 140D.

In some examples, after one or more of the dry reflectance reads on the chemistry slides 140A, 140B, 140C, and/or 140D are performed, the slide tray 106 can rotate such that the reference target 142 (e.g., a white tile) is within the field of view 130 to enable the dry reflectance read unit 114 to measure a reflectance value of the reference target 142, which in turn can be used to calibrate one or more LEDs of the optics module (including by adjusting the LED drive current value 134). For example, the reflectance measured for the reference target may be compared to and then reconciled with a global reflectance reference value to calibrate the LED drive current value 134. In examples, the slide tray 106 may be rotated such that the reference target 142 is within the field of view 130, and the LED drive current value 134 can be calibrated (e.g., adjusted) until the difference between a measured reflectance value of the reference target 142 (using the calibrated LED drive current value 134) and the reference reflectance value 122 substantially matches the difference indicated by one or more global reference reflectance value(s).

In examples, these LEDS may require recalibration because as they wear, higher drive currents must be applied to obtain the same illumination intensity. In examples, the LED drive currents that correspond to one or more LEDs may be analyzed, adjusted, and/or optimized by placing the reference target 142 (e.g., a white tile) in the field of view of the optics module, and stepping through the drive currents for each LED individually until one or more drive currents are identified that lead to the highest measured signals. In examples, when used in combination with the dry chemistry calibration methods described above, the calibration of chemistry analyzer 100 is improved, as it allows the chemistry analyzer to operate with maximum signal-to-noise ratio when undertaking the measurement and analysis of one or more of the dry reflectance reads on the chemistry slides 140A, 140B, 140C, and/or 140D.

The techniques described with respect to FIG. 2 reduce or eliminate delays associated with calibrating a chemistry analyzer. In particular, the techniques described with respect to FIG. 2 and the reference target 142 provide a mechanism to calibrate the LED drive current value 134 during downtime of the chemistry analyzer 100. As a result, the need to purchase and ship and a new reference target for calibration is reduced or eliminated. Thus, extensive delays associated with calibrating the chemistry analyzer 100, sometimes up to 72 hours, can be eliminated as the chemistry analyzer 100 can recalibrate each time a dry slide 140 is used to test samples for different substance levels.

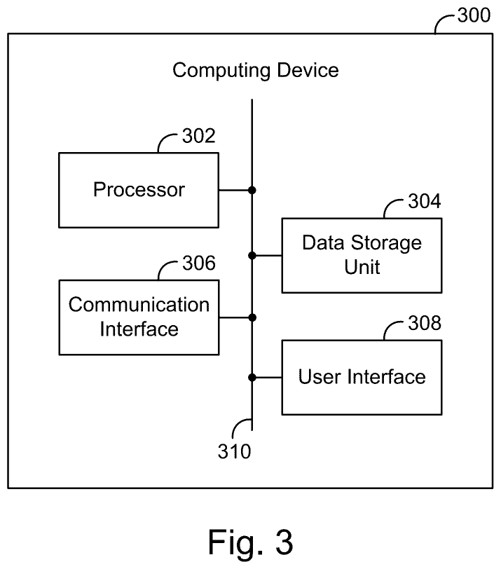

Turning to FIG. 3, FIG. 3 illustrates a simplified block diagram of an example computing device 300 of a system. In examples, the computing device 300 can correspond to the chemistry analyzer 100 of FIG. 1. In examples, the computing device 300 can include various components, such as a processor 302, a data storage unit 304, a communication interface 306, and a user interface 308. In examples, these components can be connected to each other (or to another device, system, or other entity) via connection mechanism 310.

In examples, the processor 302 can include a general-purpose processor (e.g., a microprocessor) and/or a special-purpose processor (e.g., a digital signal processor (DSP)).

In examples, the data storage unit 304 can include one or more volatile, non-volatile, removable, and/or non-removable storage components, such as magnetic, optical, or flash storage, and/or can be integrated in whole or in part with processor 302. In examples, the data storage unit 304 can take the form of a non-transitory computer-readable storage medium, having stored thereon instructions (e.g., compiled or non-compiled program logic and/or machine code) that, when executed by processor 303, cause computing device 300 to perform the operations of the controller 110.

In some instances, the computing device 300 can execute program instructions in response to receiving an input, such as from communication interface 306 and/or the user interface 308.

In examples, the communication interface 306 can allow computing device 300 to connect to and/or communicate with another other entity according to one or more protocols. In one example, the communication interface 306 can be a wired interface, such as an Ethernet interface or a high-definition serial-digital-interface (HD-SDI). In another example, the communication interface 306 can be a wireless interface, such as a cellular or WI FI interface. In this disclosure, a connection can be a direct connection or an indirect connection, the latter being a connection that passes through and/or traverses one or more entities, such as a router, switch, or other network device. Likewise, in this disclosure, a transmission can be a direct transmission or an indirect transmission.

In examples, the user interface 308 can facilitate interaction between computing device 300 and a user of computing device 300, if applicable. As such, in examples, the user interface 308 can include input components such as a keyboard, a keypad, a mouse, a touch sensitive panel, a microphone, a camera, and/or a movement sensor, all of which can be used to obtain data indicative of an environment of computing device 300, and/or output components such as a display device (which, for example, can be combined with a touch sensitive panel), a sound speaker, and/or a haptic feedback system. More generally, in examples, the user interface 308 can include hardware and/or software components that facilitate interaction between computing device 300 and the user of the computing device 300. Other examples are possible.

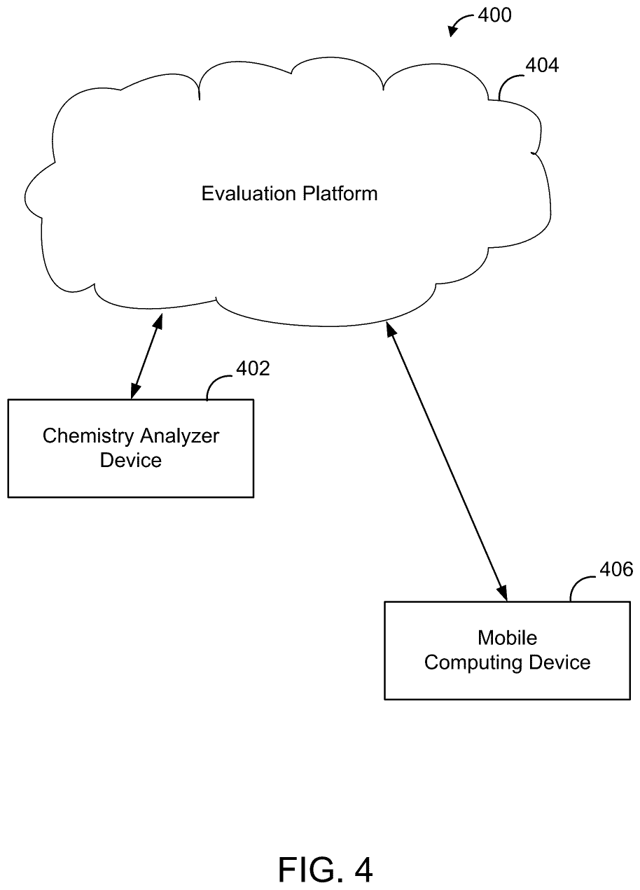

Now referring to FIG. 4, a computing system 400 configured for use with a chemistry analyzer device 402 and a mobile computing device 406 is illustrated, according to an example embodiment. Example slides (including chemistry slides and/or reference targets) are compatible with a chemistry analyzer device 402 that can read one or more signals (e.g., reflectance values) of one or more substances present on one or more chemistry slides and/or reference targets presented on a slide tray of the chemistry analyzer. In examples, these signals may include a one or more values associated with light (e.g., reflectance, color, intensity) and/or other optical parameters associated with one or more substances on the one or more chemistry slides and/or reference targets. In a further aspect, in examples, the chemistry analyzer device may detect an image present on the one or more chemistry slides that is associated with a particular substance present in the one or more chemistry slides.

In examples, the chemistry analyzer device 402 includes a computing device, such as the computing device illustrated in FIG. 1 and/or computing device 300. It should also be readily understood that computing device 300 and the chemistry analyzer device 402, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 400 can include various components, such as the computing device 300, chemistry analyzer device 402, and a cloud-based evaluation platform.

The chemistry analyzer device 402 and/or components thereof can perform various acts and/or functions (many of which are described above). Examples of these and related features will now be described in further detail.

The chemistry analyzer device 402 may collect data from a number of sources. In one example, the chemistry analyzer device 402 may collect data from a database of values (e.g., reflectance values), parameters, and/or images related to the calibration of chemistry analyzer device 402 and/or the testing of biological samples therein. These values (e.g., reflectance values), parameters, and/or images may be uploaded to an evaluation platform 404 and characteristics of these values, parameters, and/or images may be output to a mobile computing device 406.

In an example, evaluation platform 404 may collect data from one or more sensors communicably coupled to the chemistry analyzer device 402 (such as optics module 104), concerning a particular substance and/or slide. In such examples, the evaluation platform 404 may identify a characteristic of the slide or a testing result and transmit instructions to the mobile computing device 406 to cause a graphical user interface to display a graphical indication of the identified characteristic and/or testing result. In some examples, the evaluation platform 404 may analyze and evaluate a calibration parameter and/or testing result by utilizing one or more of: (i) an artificial neural network, (ii) a support vector machine, (iii) a regression tree, or (iv) an ensemble of regression trees.

In some examples, values (e.g., reflectance values), parameters, and/or images that are captured by the chemistry analyzer device 402 can be stored within a memory, such as a memory of chemistry analyzer device 100 and/or computing device 300, to be subsequently analyzed.

For example, in some embodiments, the chemistry analyzer device 402 may measure a reflectance value for a chemistry slide containing a chemical substance and then compare the measured reflectance value to one or more global reference reflectance values associated with the chemical substance on the slide. Additionally or alternatively, in examples, chemistry analyzer device 402 may reconcile the measured and global reference reflectance values and adjust one or more operational parameters of one or more components of the chemistry analyzer to reach and/or operate within a predetermined operation threshold. In some examples, the chemistry analyzer may then transmit one or more of these values to evaluation platform 404 for further analysis, including for updated values and/or instructions determined for chemistry analyzer device 402 by evaluation platform 404 based on the transmitted data.

In one example, the evaluation platform 404 may train a machine learning model using data associated values (e.g., reflectance values), parameters, and/or images of one or more slides that share a characteristic with previously captured values (e.g., reflectance values), parameters, and/or images of one or more slides. The machine learning model may be trained using training data that shares a characteristic and/or testing result with the slides (and the substances thereon and/or characteristics thereof) to be further analyzed by the chemistry analyzer device 402, evaluation platform 404, or both. Training the machine learning model may include inputting one or more training values, parameters, and/or images into the machine learning model, predicting, by the machine learning model, an outcome of a determined condition of the one or more training values, parameters, and/or images, comparing the at least one outcome to the characteristic of the one or more training values, parameters, and/or images, and adjusting, based on the comparison, the machine learning model.

In some examples, the training data may include labeled input values, parameters, and/or images (supervised learning), partially labeled input values, parameters, and/or images (semi-supervised learning), or unlabeled input values, parameters, and/or images (unsupervised learning). In some examples, training may include reinforcement learning.

The machine learning model may include an artificial neural network, a support vector machine, a regression tree, an ensemble of regression trees, or some other machine learning model architecture or combination of architectures.

In some examples, the machine learning model of the evaluation platform 404 and/or the operation of chemistry analyzer device 402 may be adjusted based on training such that if the outcome of a determined testing result matches the characteristic and/or testing result of the training values, parameters, and/or images, the machine learning model is reinforced and if the outcome of a determined testing result does not match the characteristic of the training values, parameters, and/or images, the machine learning model and/or operation of chemistry analyzer 402 is modified. In some examples, modifying the machine learning model includes increasing or decreasing a weight of a factor within the neural network of the machine learning model. In other examples, modifying the machine learning model includes adding or subtracting rules during the training of the machine learning model.

In a further aspect, these improvements of analyzing values, parameters, and/or images captured by chemistry analyzer device 402 will in turn improve the accuracy and precision of the calibration sequence and operational parameters of chemistry analyzer device 402. Further, once the chemistry analyzer device 402 has been properly calibrated and determined a characteristic of a biological sample in one or more slides, chemistry analyzer device 402 may transmit instructions that cause a computing device (e.g., the computing device 300) to display one or more graphical indications of the identified characteristic and/or one or more images of the biological sample.

In some example embodiments, the biological sample testing may include analyzing of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, Cl, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

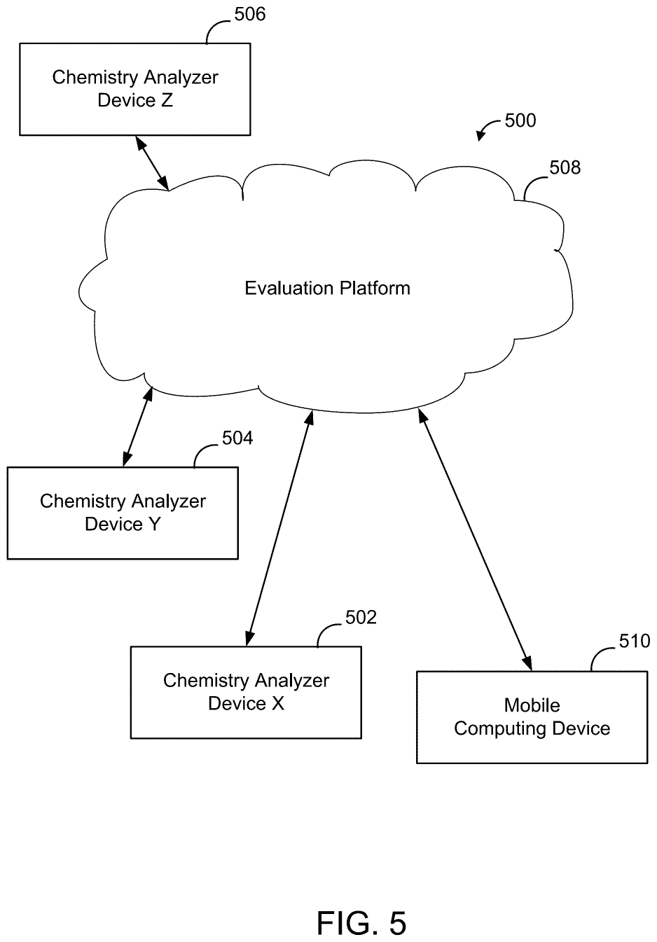

Now referring to FIG. 5, a computing system 500 configured for use with a plurality of chemistry analyzer devices (including chemistry analyzer device X 502, chemistry analyzer device Y 504, and chemistry analyzer device Z 506) and a mobile computing device 510 is illustrated, according to an example embodiment. Like the computing system 400 illustrated in FIG. 4 and described above, all of the components of computing system 500 can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, like computing system 400, computing system 500 can use one or more of chemistry analyzer device X 502, chemistry analyzer device Y 504, and chemistry analyzer device Z 506 to collect data from a number of sources, including from a database of values (e.g., reflectance values), parameters, and/or images related to the calibration of chemistry analyzer device X 502, chemistry analyzer device Y 504, and chemistry analyzer device Z 506 and/or the testing of biological samples therein. These values (e.g., reflectance values), parameters, and/or images may be uploaded to an evaluation platform 508 and characteristics of these values, parameters, and/or images may be output to a mobile computing device 510.

In some examples, values (e.g., reflectance values), parameters, and/or images that are captured by the one or more of chemistry analyzer device X 502, chemistry analyzer device Y 504, and/or chemistry analyzer device Z 506 can be stored within a memory, such as a memory of chemistry analyzer device 100 and/or computing device 300, to be subsequently analyzed.

For example, in some embodiments, one or more of chemistry analyzer device X 502, chemistry analyzer device Y 504, and/or chemistry analyzer device Z 506 may determine a reflectance value for a chemistry slide containing a chemical substance and a reference reflectance value for a reference target associated with the chemistry analyzer. Based on these determined values, one or more of chemistry analyzer device X 502, chemistry analyzer device Y 504, and/or chemistry analyzer device Z 506 may also determine one or more global reference reflectance values for the reference target (e.g., based on comparing the reflectance value to one or more predetermined reflectance values associated with the chemical substance). Further, in examples, one or more of chemistry analyzer device X 502, chemistry analyzer device Y 504, and/or chemistry analyzer device Z 506 may then use one or more of these values to take one or more responsive actions, including calibrating one or more components of their respective optics modules. Additionally or alternatively, in examples, one or more of chemistry analyzer device X 502, chemistry analyzer device Y 504, and/or chemistry analyzer device Z 506 may transmit one or more of these values to evaluation platform 508 for further analysis, including for updated values and/or instructions determined for one or more of chemistry analyzer device X 502, chemistry analyzer device Y 504, and/or chemistry analyzer device Z 506 by evaluation platform 508 based on the transmitted data.

In an example, evaluation platform 508 may collect data from one or more sensors communicably coupled to one or more of chemistry analyzer device X 502, chemistry analyzer device Y 504, and chemistry analyzer device Z (such as an optics module on or more of the devices), and use this collected data identify a characteristic of a slide and/or a testing result associated with one or more of chemistry analyzer device X 502, chemistry analyzer device Y 504, and/or chemistry analyzer device Z 506. In one aspect, in an example embodiment, evaluation platform 508 may use a value (e.g., a reflectance value) received from a particular chemistry analyzer device (e.g., chemistry analyzer device X 502) to update a value stored in the evaluation platform, one or more chemistry analyzer devices (e.g., chemistry analyzer device Y 504 and/or chemistry analyzer device Z 506), or both, among other possibilities. For example, evaluation platform 508 may use a global reflectance reference value determined by a particular chemistry analyzer device (e.g., chemistry analyzer device X 502) to update a global reflectance reference value stored in the evaluation platform and/or one or more other chemistry analyzer devices (e.g., chemistry analyzer device Y 504 and/or chemistry analyzer device Z 506). In this regard, in examples, the analysis and calibration undertaken by a particular chemistry analyzer device may be utilized and leveraged to improve the accuracy, precision, and technical operation of other chemistry analyzer devices, as well as of the evaluation platform itself. Other examples are possible.

In a further aspect, in examples, the evaluation platform 508 may transmit instructions to the mobile computing device 510 to cause a graphical user interface to display a graphical indication of the identified update, sample characteristic, and/or testing result.

In some examples, the evaluation platform 508 may analyze and evaluate one or more calibration parameters and/or testing result by utilizing one or more of: (i) an artificial neural network, (ii) a support vector machine, (iii) a regression tree, or (iv) an ensemble of regression trees, as well as by training one or more machine learning models using data associated values (e.g., reflectance values), parameters, and/or images of one or more slides that share a characteristic with previously captured values, parameters, and/or images of one or more slides. As described in further detail above, the training data may include labeled input values, parameters, and/or images (supervised learning), partially labeled input values, parameters, and/or images (semi-supervised learning), or unlabeled input values, parameters, and/or images (unsupervised learning), as well as reinforcement learning, and the machine learning models described herein may include an artificial neural network, a support vector machine, a regression tree, an ensemble of regression trees, or some other machine learning model architecture or combination of architectures. Other examples are possible.

### Example Methods and Aspects

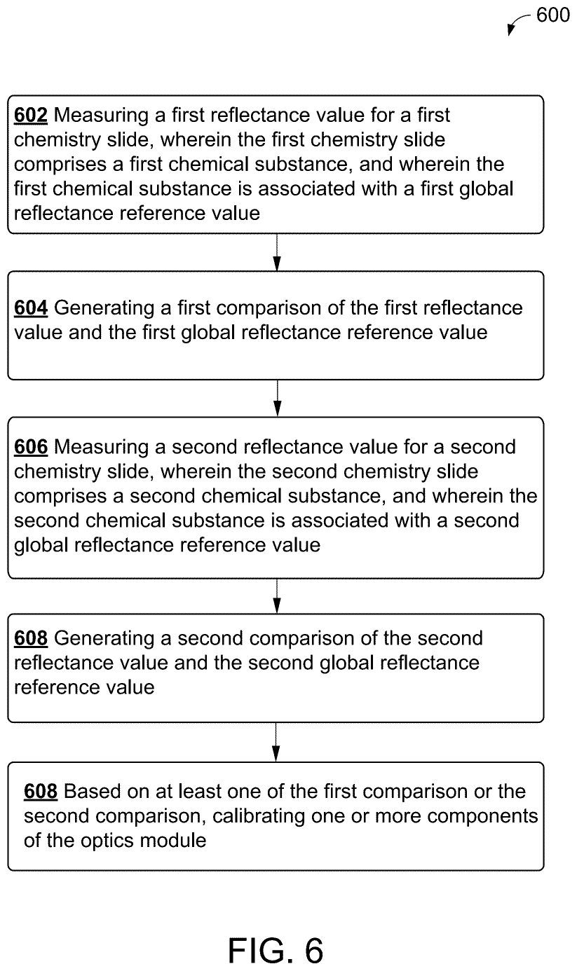

Now referring to FIG. 6, an example method 600 of calibrating an optics module of a chemistry analyzer is disclosed. The method 600 shown in FIG. 6 presents an example of a method that could be used with the components shown in FIGS. 1-5, for example. Further, devices or systems may be used or configured to perform logical functions presented in FIG. 6. In other examples, components of the devices and/or systems may be arranged to be adapted to, capable of, or suited for performing the functions, such as when operated in a specific manner. In examples, the method 600 may include one or more operations, functions, or actions as illustrated by one or more of blocks 602-610. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 602, in examples, the method 600 of calibrating the optics module of the chemistry analyzer includes measuring a first reflectance value for a first chemistry slide, wherein the first chemistry slide comprises a first chemical substance, and wherein the first chemical substance is associated with a first global reflectance reference value. In some examples, the first chemistry slide may include a reagent strip. In some examples, the first chemical substance may include a chemical substance to measure one or more of alkaline phosphatase, blood urea nitrogen, creatinine, or glucose. In some examples, the first global reflectance reference value may include a predetermined reflectance value for one or more substances on a reagent strip of the first chemistry slide. In some examples, the first chemical substance may include a chemical substance to measure one or more of alkaline phosphatase, blood urea nitrogen, creatinine, or glucose. In some examples, referring to FIG. 1, the dry reflectance read unit 114 may determine the reflectance value 150A for the chemistry slide 140A while the chemistry slide 140A is placed in a corresponding slot of the slide tray and positioned within the field of view 130 of the optics module 104 and prior to a biological test sample being applied to the chemistry slide 140A.

At block 604, in examples, the method 600 includes generating a first comparison of the first reflectance value and the first global reflectance reference value. In some examples, referring to FIG. 1, the controller 110 may compare the measured reflectance value with the reference reflectance value 122 of the chemistry slide 140A and/or one or more global reflectance reference values associated with one or more chemical substances disposed thereon (e.g., a chemical substance to measure alkaline phosphate).

At block 606, in examples, the method 600 includes measuring a second reflectance value for a second chemistry slide, wherein the second chemistry slide comprises a second chemical substance, and wherein the second chemical substance is associated with a second global reflectance reference value. In some examples, the second chemical substance may include a chemical substance to measure one or more of alkaline phosphatase, blood urea nitrogen, creatinine, or glucose. In some examples, the second global reflectance reference value may include a predetermined reflectance value for one or more substances on a reagent strip of the second chemistry slide. In some examples, the second chemical substance may include a chemical substance to measure one or more of alkaline phosphatase, blood urea nitrogen, creatinine, or glucose. In some examples, referring to FIG. 1, the dry reflectance read unit 114 may determine the reflectance value 150B for the chemistry slide 140B while the chemistry slide 140B is placed in a corresponding slot of the slide tray and positioned within the field of view 130 of the optics module 104 and prior to a biological test sample being applied to the chemistry slide 140B.

In some examples, the first chemical substance and the second chemical substance are different chemical substances. In some examples, the first chemical substance and the second chemical substance are the same chemical substance. In some examples, measuring the first reflectance value comprises performing a dry reflectance read on the first chemistry slide, and wherein measuring the second reflectance value comprises performing a dry reflectance read on the second chemistry slide.

At block 608, in examples, the method 600 includes generating a second comparison of the second reflectance value and the second global reflectance reference value. In some examples, referring to FIG. 1, the controller 110 may compare the measured reflectance value with the reference reflectance value 122 of the chemistry slide 140A and/or one or more global reflectance reference values associated with one or more chemical substances disposed thereon (e.g., a chemical substance to measure blood urea nitrogen).

At block 610, in examples, the method 600 includes based on at least one of the first comparison or the second comparison, calibrating one or more components of the optics module. In some examples, calibrating one or more components of the optics module comprising generating one or more scalar calibration values, and wherein the one or more scalar calibration values are used to reconcile at least one of: (i) the first reflectance value and the first global reflectance reference value; and (ii) the second reflectance value and the second global reflectance reference value. In some examples, at least one of the first comparison or the second comparison indicate that the one or more components of the optics module are operating outside of a predetermined tolerance, and wherein calibrating the one or more components of the optics module comprises adjusting at least one component of the optics module to bring the one or more components of the optics module within the predetermined tolerance.

In some examples, method 600 further comprises: (i) measuring a reference target reflectance value for a reference target, wherein the reference target is associated with a reference target global reflectance reference value, (ii) generating a reference target comparison of the reference target reflectance value and the reference target global reflectance reference value, and (iii) based on reference target comparison, calibrating one or more light emitting diodes (LEDs) of the optics module. For example, referring to FIG. 1, the controller 110 may calibrate the LED drive current value 134 for the optics module 104 based on measuring the reflectance value of the reference target 142 and then comparing the measure reflectance to at least one the reference reflectance value 122 and the global reference reflectance value 160A. In some examples of the method 600, the reference target comprises a white tile. In some examples, during calibration of the one or more LED drive current values, the reference target is within a field of view of the optics module.

In some examples, the method 600 further comprises, prior to generating the first comparison or the second comparison, receiving at least one of the first global reflectance reference value and the second global reflectance reference value from an evaluation platform. In some examples, the method 600 also includes, transmitting at least one of the first comparison and the second comparison to an evaluation platform and based on transmitting the at least one of the first comparison and the second comparison to the evaluation platform, updating one or more of the first global reflectance reference value and the second global reflectance reference value in the evaluation platform.

In some examples, method 600 further comprises determining that a reflectance metric of at least one of the first chemical substance or the second chemical substance exceeds a wavelength of interest of the chemistry analyzer. In some examples, the wavelength of interest is between 350 nanometers and 780 nanometers.

In one aspect, an example chemistry analyzer is disclosed. In examples, the chemistry analyzer includes an optics module, one or more processors, and a tangible, non-transitory computer-readable medium comprising instructions that, when executed by the one or more processors, cause performance of a set of operations. In one aspect, the set of operations comprise: (i) measuring a first reflectance value for a first chemistry slide, wherein the first chemistry slide comprises a first chemical substance, and wherein the first chemical substance is associated with a first global reflectance reference value; (ii) generating a first comparison of the first reflectance value and the first global reflectance reference value; (iii) measuring a second reflectance value for a second chemistry slide, wherein the second chemistry slide comprises a second chemical substance, and wherein the second chemical substance is associated with a second global reflectance reference value; (iv) generating a second comparison of the second reflectance value and the second global reflectance reference value; and (v) based on at least one of the first comparison or the second comparison, calibrating one or more components of an optics module of a chemistry analyzer.

In one aspect, an example tangible, non-transitory computer-readable medium comprising instructions that, when executed by one or more processors, cause performance of a set of operations is disclosed. In one aspect, the set of operations comprise: (i) measuring a first reflectance value for a first chemistry slide, wherein the first chemistry slide comprises a first chemical substance, and wherein the first chemical substance is associated with a first global reflectance reference value; (ii) generating a first comparison of the first reflectance value and the first global reflectance reference value; (iii) measuring a second reflectance value for a second chemistry slide, wherein the second chemistry slide comprises a second chemical substance, and wherein the second chemical substance is associated with a second global reflectance reference value; (iv) generating a second comparison of the second reflectance value and the second global reflectance reference value; and (v) based on at least one of the first comparison or the second comparison, calibrating one or more components of an optics module of a chemistry analyzer.

The singular forms of the articles “a,” “an,” and “the” include plural references unless the context clearly indicates otherwise. For example, the term “a compound” or “at least one compound”can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

We claim:

1. A method for calibrating an optics module of a chemistry analyzer, the method comprising:
measuring a first reflectance value for a first chemistry slide, wherein the first chemistry slide comprises a first chemical substance, and wherein the first chemical substance is associated with a first global reflectance reference value;
generating a first comparison of the first reflectance value and the first global reflectance reference value;
measuring a second reflectance value for a second chemistry slide, wherein the second chemistry slide comprises a second chemical substance, and wherein the second chemical substance is associated with a second global reflectance reference value;
generating a second comparison of the second reflectance value and the second global reflectance reference value; and
based on at least one of the first comparison or the second comparison, calibrating one or more components of the optics module.

2. The method of claim 1, wherein at least one of the first chemistry slide and the second chemistry slide comprises a reagent strip.

3. The method of claim 2, wherein at least one of the first global reflectance reference value and the second global reflectance reference value comprises a predetermined reflectance value for one or more substances on the reagent strip.

4. The method of claim 1, wherein the first chemical substance comprises a chemical substance to measure one or more of alkaline phosphatase, blood urea nitrogen, creatinine, or glucose.

5. The method of claim 1, wherein the second chemical substance comprises a chemical substance to measure one or more of alkaline phosphatase, blood urea nitrogen, creatinine, or glucose.

6. The method of claim 1, wherein the first chemical substance and the second chemical substance are different chemical substances.

7. The method of claim 1, wherein the first chemical substance and the second chemical substance are the same chemical substance.

8. The method of claim 1, wherein measuring the first reflectance value comprises performing a dry reflectance read on the first chemistry slide, and wherein measuring the second reflectance value comprises performing a dry reflectance read on the second chemistry slide.

9. The method of claim 1, wherein calibrating one or more components of the optics module comprising generating one or more scalar calibration values, and wherein the one or more scalar calibration values are used to reconcile at least one of: (i) the first reflectance value and the first global reflectance reference value; and (ii) the second reflectance value and the second global reflectance reference value.

10. The method of claim 1, wherein at least one of the first comparison or the second comparison indicate that the one or more components of the optics module are operating outside of a predetermined tolerance, and wherein calibrating the one or more components of the optics module comprises adjusting at least one component of the optics module to bring the one or more components of the optics module within the predetermined tolerance.

11. The method of claim 1, further comprising:
measuring a reference target reflectance value for a reference target, wherein the reference target is associated with a reference target global reflectance reference value;
generating a reference target comparison of the reference target reflectance value and the reference target global reflectance reference value; and
based on reference target comparison, calibrating one or more light emitting diodes (LEDs) of the optics module.

12. The method of claim 11, wherein calibrating one or more (LEDs) of the optics module comprises calibrating one or more LED drive current values for the optics module.

13. The method of claim 12, wherein, during calibration of the one or more LED drive current values, the reference target is within a field of view of the optics module.

14. The method of claim 11, wherein the reference target comprises a white tile.

15. The method of claim 1, further comprising:
prior to generating the first comparison or the second comparison, receiving at least one of the first global reflectance reference value and the second global reflectance reference value from an evaluation platform.

16. The method of claim 1, further comprising:
transmitting at least one of the first comparison and the second comparison to an evaluation platform; and
based on transmitting the at least one of the first comparison and the second comparison to the evaluation platform, updating one or more of the first global reflectance reference value and the second global reflectance reference value in the evaluation platform.

17. The method of claim 1, further comprises determining that a reflectance metric of at least one of the first chemical substance or the second chemical substance exceeds a wavelength of interest of the chemistry analyzer.

18. The method of claim 17, wherein the wavelength of interest is between 350 nanometers and 780 nanometers.

19. A chemistry analyzer comprising:
an optics module;
one or more processors; and
a tangible, non-transitory computer-readable medium comprising instructions that, when executed by the one or more processors, cause performance of a set of operations comprising:
measuring a first reflectance value for a first chemistry slide, wherein the first chemistry slide comprises a first chemical substance, and wherein the first chemical substance is associated with a first global reflectance reference value;
generating a first comparison of the first reflectance value and the first global reflectance reference value;
measuring a second reflectance value for a second chemistry slide, wherein the second chemistry slide comprises a second chemical substance, and wherein the second chemical substance is associated with a second global reflectance reference value;
generating a second comparison of the second reflectance value and the second global reflectance reference value; and
based on at least one of the first comparison or the second comparison, calibrating one or more components of the optics module.

20. A method for calibrating an optics module of a chemistry analyzer, the method comprising:
measuring a reflectance value for a chemistry slide, wherein the chemistry slide comprises a chemical substance, and wherein the chemical substance is associated with a global reflectance reference value;
generating a comparison of the reflectance value and the global reflectance reference value; and
based on the comparison, calibrating one or more components of the optics module.

21. A chemistry analyzer comprising:
an optics module;
one or more processors; and
a tangible, non-transitory computer-readable medium comprising instructions that, when executed by the one or more processors, cause performance of a set of operations comprising:
measuring a reflectance value for a chemistry slide, wherein the chemistry slide comprises a chemical substance, and wherein the chemical substance is associated with a global reflectance reference value;
generating a comparison of the reflectance value and the global reflectance reference value; and
based on the comparison, calibrating one or more components of the optics module.
